(19) United States
(12) Patent Application Publication
(10) Pub. No.: US 2010/0325557 A1
(43) Pub. Date: Dec. 23, 2010

(54) ANNOTATION OF AGGREGATED CONTENT, SYSTEMS AND METHODS

(76) Inventor: Agostino Sibillo, Perris, CA (US)

Correspondence Address: FISH & ASSOCIATES, PC;ROBERT D. FISH, 2603 Main Street, Suite 1000, Irvine, CA, 92614-6232, US

(21) Appl. No.: 12/820,831

(22) Filed: Jun. 22, 2010

Related U.S. Application Data
(63) Continuation-in-part of application No. 12/817,994, filed on Jun. 17, 2010.
(60) Provisional application No. 61/187,910, filed on Jun. 17, 2009.
(60) Provisional application No. 61/219,215, filed on Jun. 22, 2009.

(51) Int. Cl. G06F 3/01

(52) U.S. Cl. 715/751

(57) ABSTRACT

Systems and methods of annotating aggregated on-line content within a defined context are presented. A context composer can define a context by defining one or more context attributes including network addresses of remote content and an arrangement of the content according to a desired presentation. The composer, or other viewer of a context, can utilize an annotation interface to submit annotations to the context. The annotations can be bound to the arrangement of the context via the annotation interface and integrated into the defined context. One or more viewers can observe the annotations, possibly as the annotations are made in real-time.

This application is a continuation-in-part of U.S. patent application Ser. No. 12/817,994 filed on Jun. 17, 2010, which claims the benefit of priority to U.S. provisional application having Ser. No. 61/187,910 filed on Jun. 17, 2009, and claims the benefit of priority to U.S. provisional application having Ser. No. 61/219,215 filed on Jun. 22, 2009. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is aggregated data access technologies.

### BACKGROUND

Current Internet browsing technologies allow individuals to access remote content using browser applications. Browsers have evolved from applications that simply render remote content into highly complex interfaces that can access on-line applications (e.g., Google Apps, games, etc.). However, users still generally browse a single content source at time using their browsers. Newer browsers have been adapted to allow users to browse multiple sources at the same time via a tabbed interface where each tab represents content obtained from a different source. Each link of a tab is treated individually outside of a desired context. Unfortunately, browser applications lack any means for defining a context in which content is viewed.

One of the many problems with browsing technologies is that a user must direct a browser to multiple sources via multiple links in order to put the content into a desired context. Such an approach is cumbersome and time consuming. Some effort has be put forth to allow users to arrange content as they like. For example, U.S. Pat. No. 7,702,635 to Horvitz et al. titled “System and Methods for Constructing Personalized Context-Sensitive Portal Pages or Views by Analyzing Patterns of Users' Information Access Activities”, filed Jul. 27, 2005, discusses forming a coalesced display or montage of aggregated information. In a similar vein, U.S. Pat. No. 7,725,530 to Sah et al. titled “Proxy Server Collection of Data for Module Incorporation into a Container Document”, filed Dec. 12, 2005, describes a system where proxy server can form a container page according to various formats.

Although users are able to define an arrangement of content for personal use, users still lack an ability to send a constructed context along with the content to another user, let alone provide for annotating the constructed context to provide additional information on how portions of the content relate to other portions of the context. For example, International application publication WO 00/65773 to Cowden et al. titled “Portal System and Method”, filed Apr. 27, 2000, describes a system where a user can define a portal, through which the user can obtain data. Unfortunately, the user can not provide their portal definitions to others. If a first user wishes to send related content to a second user; the first user must send multiple links, possibly within an email, where each link points to each source of the content. Alternatively the first user could provide a remote desktop view to the second user. However, the users are still forced to launch multiple browser instances, browser tabs, manage links individually, or lack the ability to annotate a context as a whole in a collaborative fashion.

Ideally, a user should be able to arrange content from independent content sources in a desired arrangement to put the content into a desired context. The user should also be able to send a single link to a recipient through which the recipient can obtain the context with the content placed according a defined arrangement of the context. When the recipient clicks on the link, the recipient's browser should present all the content within the same context as defined by the user, possibly through the use of a proxy browsing service. Furthermore, the recipient, or the user, should able to annotate the context as a whole.

Additional examples of previous effort put forth toward aggregating content and using of proxies include the following references.

U.S. Pat. No. 7,673,327 to Polis et al. titled “Aggregation System”, filed Jun. 27, 2007, describes a system for aggregating services.

U.S. Pat. No. 7,711,788 to Lev Ran et al. titled “Double-Proxy Remote Data Access System”, filed Jul. 26, 2007, discusses methods of obtaining access to a data resource via proxies.

U.S. patent publication 2010/0082431 to Ramer et al. titled “Contextual Mobile Content Placement on a Mobile Communication Facility”, filed Jun. 12, 2009, discusses receiving contextual information relating to a web request, associating the contextual information with mobile content, and finally displaying the mobile content to a user.

U.S. patent publication 2010/0100952 to Sample et al. titled “Network Aggregator”, filed Jan. 23, 2009, also describes an aggregation system that obtains data or services, which can be converted into an aggregatable form.

U.S. patent publication 2010/0125623 to Rice et al. titled “Cross-Domain Communication Technique for Execution of Web Mashups”, filed Nov. 18, 2008, discusses using a proxy server between a client computer and third party services to create a web mashup to avoid problems arising from a Same Origin Policy.

Additional effort has been directed toward annotating web-based documents as discussed in the following references.

U.S. patent application publication 2008/0059535 to Lindsley et al. titled “Annotating Media Content with Related Information”, filed Aug. 29, 2006, describes processing metadata associated with a media file to identify other media files of interest.

U.S. patent application publication 2009/0193032 to Pyper titled “Advertisement System and Method”, filed Jan. 26, 2009, discusses using overlay markers for a media file where the markers indicate an annotation at a specific point in time.

U.S. patent application publication 2010/0070845 to Facemire et al. titled “Shared Web 2.0 Annotations Linked to Content Segments of Web Documents”, filed Sep. 17, 2008, discusses that annotations can be associated with a content segment of a web document.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Interestingly, although others have contemplated associating annotations with web documents, it has yet to be appreciated annotations can be bound to a context of content where a context can be defined (e.g., arrangement of content, tagged attributes of content, annotations, etc.) and presented to another user. When a user clicks on a context's web-link, their browser is directed to an aggregation server, which in turn provides instructions to a browser to construct the context on the browser for the user. The aggregation server can obtain the context's content as a proxy browser where the content passes through the server to the browser. The content can then be presented within the browser in format according to the defined context. Furthermore, the aggregating server can provide an annotation interface though which context recipients can view annotations, edit annotations, create annotations, or otherwise manage annotations, possibly in a collaborative setting. Additionally, the annotations can be bound to various aspects of the context's arrangement.

Thus, there is still a need for annotating a context of aggregated content.

### SUMMARY OF THE INVENTION

The inventive subject matter provides apparatus, systems and methods in which one can annotate a context of aggregated content in a shared environment. One aspect of the inventive subject matter includes a context aggregating server capable of supporting annotation of a context where the context comprises an arrangement of content. The context server can operate as a proxy browser capable of obtaining content from remote independent content sources. The context server is preferably communicatively coupled to one or more context recipients and to the remote independent content source over a network, where the context server can provide an intermediary communication service between the recipients and the content sources. Preferred context servers are configured to present a context to a recipient in response to receiving a context request. In some embodiments, the context comprises a context identifier, possibly a context network address, and a defined arrangement of content obtained from the remote content sources. As the recipient receives the context, the context is rendered at the recipient's location under instructions from the context server. Additionally, the context server can be configured to present a context annotation interface along with the context, where the annotation interface can be constructed via instructions served from the context server to the recipient's computer system. Contemplated annotation interfaces allow one or more recipients viewing the context to annotate the context as a whole, possibly in a collaborative fashion. Annotations can include text, audio, images, video, graphics, or other digital data that can be bound to the context. As the recipients annotate the context, the context server is able to bind the annotations to the arrangement of the context. Furthermore, the context server can update the context to reflect changes to the annotations or changes in the context according to how the annotations are bound to the context.

Yet another aspect of the inventive subject includes methods of annotating an aggregated context especially where multiple context viewers are able to annotate the context. Such methods can include configuring an interface to allow for annotations, receiving annotations, binding annotations to a context, or modifying a context to reflect changes in annotations or changes in the context. In some embodiments, one or more of the steps occur in real time, or in response to multiple context recipients' annotations.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an aggregating proxy server system.

FIG. 2 is a schematic of a context interface through a user can define a context of content.

FIG. 3 is a possible method for aggregating on-line data via a proxy.

FIG. 4 is a schematic of a rendered context having an annotation interface.

### DETAILED DESCRIPTION

It should be noted that while the following description is drawn to a computer/server based context providing service, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including presenting a defined context to one or more remote individuals external to the proxy context servers and allowing one or more of the remote individual to annotate the context as a whole. The annotations can then be presented to others as desired.

The present inventive subject matter is drawn to systems, configurations, and methods of providing access to distributed content obtained from independent content sources, and to presenting the content within a defined context along with annotations. A context is considered to represent a collection of content presented according to an arrangement (e.g., rules, instructions, programmatic code, etc.), where the context is treated as an object that comprises one or more defining attributes. Content is considered to include digital data that can be presented to a user, preferably through a browser application; the digital data can comprise images, video, audio, text, application data, web pages, blogs, feeds, streams, broadcast data, or other data that can be presented via a browser. The content can be presented, or otherwise rendered, according to the type of content. For example, the content can be presented by playing audio data, displaying images, playing video data, executing software instructions, or transforming the content data into format that is consumable by a browsing user. The content can also include annotations bound to the context, possibly bound to the arrangement of the content in the context to maintain relative positioning of annotations to portions of the content.

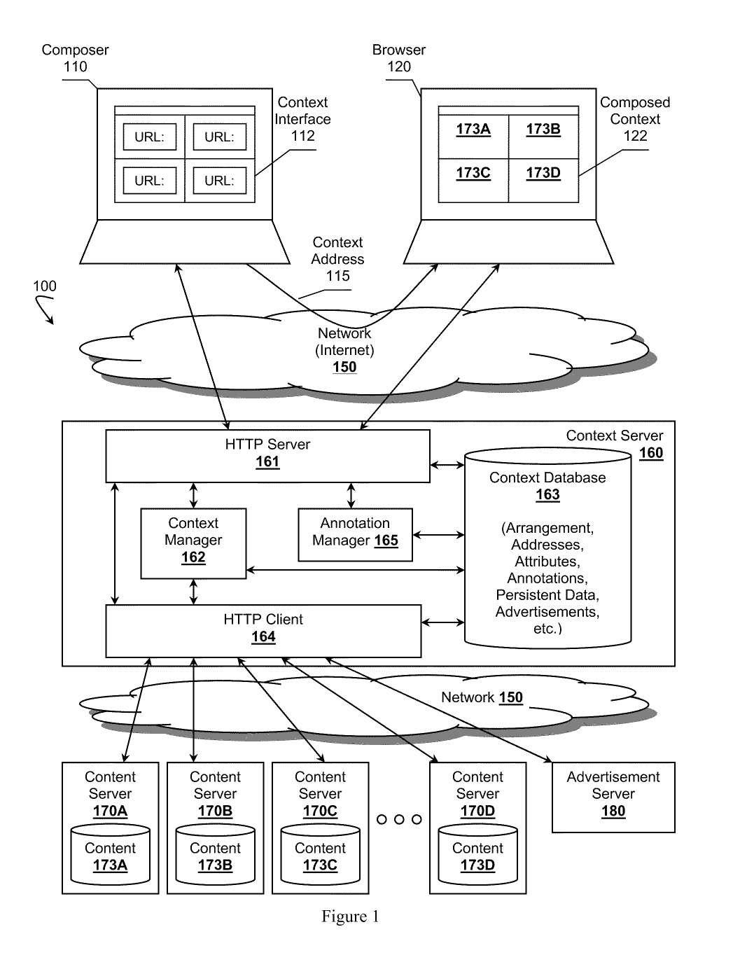

In FIG. 1, content aggregating proxy system 100 comprises an intermediary context server 160 that is communicatively between browser 120 and content servers 170A through 170D, collectively referred to as content servers 170 (e.g., source of content). Context server 160 can operate as a proxy browser over network 150 for browser 120 and in response to context requests submitted by browser 120. Context server 160 can obtain content 173A through 173D, collectively referred to as content 173, when server 160 receives the context request. Server 160 provides content 173 to browser 120 and instructs browser 120 to present content 173 according to context 122 as defined by composer 110 via context interface 112.

Network 150 preferably comprises a packet switched network (e.g., LAN, WAN, Internet, etc.). It is also noted that any network 150 can be employed as long as network 150 can provide for data transport. In some especially contemplated embodiments, network 150 can include cell phone networks (e.g., CDMA, GSM, TDMA, etc.), where browser 120 can include a mobile device (e.g., PDA, game console, cell phone, camera, etc.).

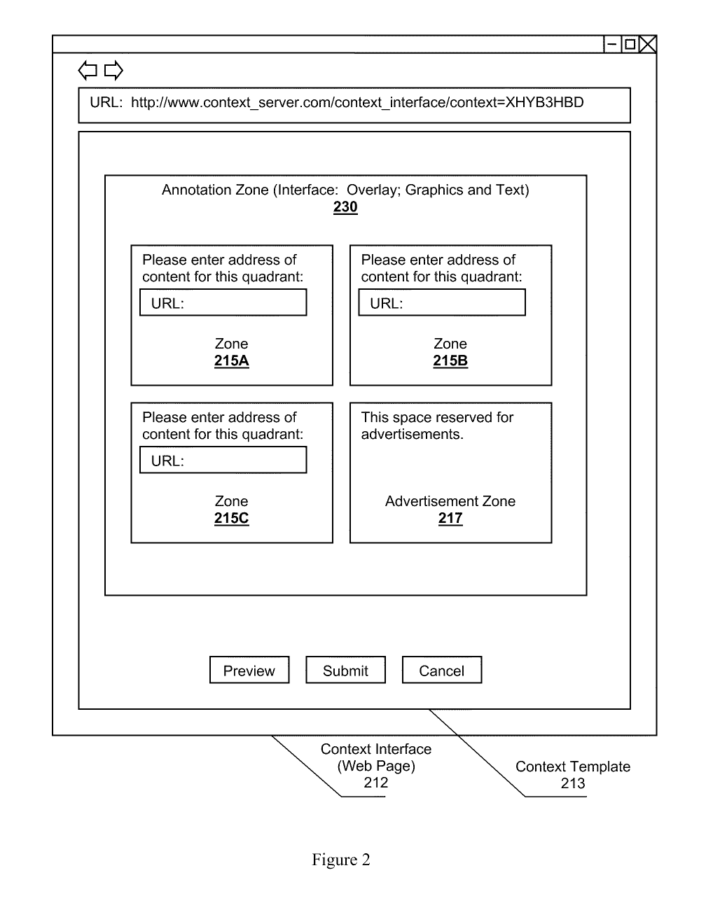

Composer 110 can represent a computer configured to communicate with context server 160 via HTTP server 161, possibly through known HTTP communication protocols. Composer 110 preferably comprises a browser application that renders context interface 112, through which an individual can define context 122 comprising any desired content located on remote servers 170. In some embodiments, context interface 112 can also include an annotation interface that allows an individual to annotate the context 122 they are creating the context. Additional information relating to context interface 112 is presented below with respect to FIG. 2.

Once a user is satisfied with context 122, a context address 115 is assigned to the context. The context network address 115 can be sent to a recipient located at browser 120. The recipient can instruct browser 120 to connect to context server 160 via context address 115. In response, context server 160 instructs browser 120 to display context 122. If annotations are present or are permitted, context 122 can also include an annotation interface though which the recipient can view annotations or possibly manage annotations (e.g., edit, deleted, save, modify, etc.)

One should appreciate that context 122 is considered to be an object of value and a distinct entity that can be managed separately from content 173. Context 122 has value because a first individual constructing a desired content arrangement wishes to communicate a complex idea to a recipient, where the idea or concept can not ordinarily be communicated by a single representation of content 173A through 173D. The context comprises a codified representation of one or more over arching themes. Therefore, context 122 can be leveraged as a valuable commodity for the individuals, for the recipient, for the service operating context server 160, or possibly others (e.g., advertisers, marketers, etc.). Communication of a theme is further enhanced through the use of annotations that indicate relationships among related concepts of independent content 173 within context 122.

Content servers 170 represent one or more remote, independently operated sources of content. Each of servers 170 can store its own content 173 and provide content 173 when it is requested at the content's network address.

As previously stated, context server 160 preferably operates an aggregating proxy browser. To support such a function, context server 160 can include HTTP server 161 that is responsive to composer 110 or browser 120. Server 160 can also include HTTP client 164 to obtain content 173 from servers 170 over network 150.

Context server 160 can also comprise context manager 162. Context manager 162 is configured to manage contexts defined by one or more remote users. Once a context has been submitted, context manager 162 can store the context definition in context database 163. One should note that a context, context 122 for example, can be stored separately from the content referenced in the context. Context database 163 can utilize known techniques to store context information (e.g., Access, MySQL, Oracle, etc.) that aids in the definition of the context.

Context manager 162 not only manages a single context, but can manage many different contexts even when defined by different users. Therefore, management activities of manager 162 are also considered to include monitoring use of a context, inventorying content within a context, logging access to a context, reporting on activities associated with a context, providing alerts or notifications to context users, or providing secure access to the contexts. Security can be maintained by requiring a user to submit authentication or authorization information (e.g., password, RADIUS, Kerberos, OpeniD, keys, etc.).

Preferably context 122, or any other context, is defined by one or more context attributes. In the example shown, context database 163 can store an arrangement of content, content addresses, user defined attributes (e.g., metadata, tags, ratings, etc), persistent data (e.g., browsing history, cookies, etc.), or other information. It is also contemplated that context database 163 can store advertisements that can be displayed within a context. Although only a few examples of context attributes are shown, all possible attributes are contemplated.

One type of especially preferred context attribute includes a content arrangement. An arrangement can include information relating to the absolute position of content within context 122 or relative placement. The arrangement can also be a 2D representation, a 3D representation, or even a temporal representation where content is displayed according to a schedule similar to a slide show or play list.

Another type of preferred context attribute includes content identifier, more preferably content network addresses. As composer 110 constructs a desired context, URLs, or other network addresses, can be entered to identify the location of content 173. Content identifiers can include URLs, URIs, GUIDs, API references, or other types of identifiers.

Context server 160 can also include annotation manager 165. Although annotation manager 165 is illustrated as a separate module from context manager 162, one should appreciate that the two modules can be combined into a single module, or possibly as separate servers. Annotation manager 165 preferably manages annotations provided from composer 110 or from browser 120, by binding the annotations to context 122. Upon reception of annotations, annotation manager 165 can store the annotations within context database 163. It should be appreciate that annotations can be considered another form of content that is locally available on context server 160 as opposed located on servers 170. Furthermore, annotations can comprise many different types of data similar to content 173 (e.g., audio, video, images, text, metadata, etc.).

One should also note that context attributes can also pertain to annotations. For example, context attributes can be considered to comprise annotation attributes (e.g., metadata, relative locations in a context, time stamps, permissions, ratings, etc.) that aid in defining annotations as member content of context 122.

In some embodiments, context server 160 can also access advertisement server 180. When browser 120 requests a context, it is contemplated that context server 160, possibly via context manager 162, can request an advertisement from advertisement server 180 based on one or more of the requested context's attributes, including annotations or annotations attributes. Context server 160 can search for or request an advertisement having one or more properties that correlate to the context's attributes (e.g., related metadata, annotations, corresponding key words, correlated metrics, etc.).

As its name implies, annotation manager 165 can be configured to manage annotations for context 122. Preferably annotations are bound to context 122 by the context's identifier (e.g., GUID, UUID, network address, URL, etc.). It is contemplated that the owner of context 122 can interact with annotation manager 165 to manage annotations in numerous ways. Example annotation management capabilities include submitting or otherwise creating annotation content, binding annotation to a context arrangement (e.g., to relative in context positions, to absolute positions in a context, to times, etc.), setting or adjusting permission or access levels, adjusting annotations visibility, assigning exclusive control for entering annotations to users, or other functions that modify annotations.

FIG. 2 presents a schematic of a possible context interface 212 through which a user can define a context by entering one or more context attributes. The example provided is greatly simplified for clarity and can be rendered within a web browser as a web page hosted by a context server. It is contemplated that context interface 212 can be presented on nearly any computing device. For example, context interface 212 could be presented on a cell phone or could be presented as part of a social networking site.

Context interface 212 preferably offers the user an option for placing content into one or more of content zones 215A-215C, advertisement zone 217, and annotation zone 230, collectively referred to as content zones. It is also contemplated that one or more content zones could be reserved as advertisement zone 217 for use with placing advertisements possibly selected based on context attributes. It is further contemplated that context interface 212 can also include annotation zone 230, through which a context composer can provide annotations regarding the context or its content. Although four main content zones are presented, five including annotation zone 230, there can also be any number of content zones. For example, it is conceivable to have over 100 content zones.

In some embodiments, as illustrated, an arrangement of a context can be based on context template 213. Such an approach minimizes effort on the user's part to construct a context. When templates are employed, the templates can be a priori defined with a specific arrangement of content zones 215, 217, or 230 (e.g., 2, 4, 6, 8, 10, 20, 100, or more zones). In some embodiments, template 213 can include an a priori defined annotation zone 230. In the example shown, annotation zone 230 represents an overlay through which the context composer can add annotations to the context in the form of graphics, text, or other data to the context by arranging the annotations as desired within zone 230. When the context is presented to a recipient the annotations can also be presented to the recipient according the defined annotation arrangement.

Although context interface 212 illustrates a priori defined content zones 215, one should appreciate that the various content zones could be defined by a user by allowing the user to adjust one or more properties of the zones. Additionally, it is contemplated that content zones could be non-visible to hide content for restricted access or for presenting non-visible content; audio data or application data for example.

Once the user is satisfied with the context definition created through context interface 212, the user could preview their work, submit the context, reset the form, or otherwise manage their context. It is also contemplated the user can engage a context manager to manage the user's contexts. For example, the user can update a saved context, monitor use of the context, view context attribute or metrics, set permission levels, or otherwise manage contexts.

The simple example of FIG. 2 illustrates a minimal context interface 212 where a user can only enter one or more content network addresses as context attributes. However, the Applicant contemplates that context interface 212 can be highly complex to accommodate the user entering various forms of context defining attributes.

In some embodiments a user can define their own content zones as discussed above. Context interface 212 can be configure to allow the user to drag-n-drop content into zones; configure size, shape, or other geometry of content zones; provide for overlapping content zones; schedule play times for content; or otherwise modify content zones 215 as desired. It is also contemplated that users can pay additional fees to override advertisement zone 217. It should be appreciated that the various content zone arrangements or geometries are considered content attributes.

In yet other embodiments, a user can include one or more rating scales as context attributes. Rating scales can include absolute scales (e.g., 1 to 10), relative scales (e.g., thumbs up or thumbs down), or even multiple valued scales (e.g., ratings for different types information). Rating scales, or other context attributes, could be presented via annotation zone 230.

In yet further embodiments, context interface 212 can also be configured to allow a user to enter metadata to be associated with the context. Metadata can be visible or non-visible as desired by the user. Metadata can be used to help classify the context or can be used to aid in selecting advertisements. It is also contemplated that a context manager can automatically tag a context with metadata. Example metadata can include time stamps, a context owner, permission levels, property-value pairs, metrics (e.g., number of views, time to live, etc.), geo-location or GPS information, topic, classification, sensor data relating to the composer's client device, or other types of information that can be used to define a context.

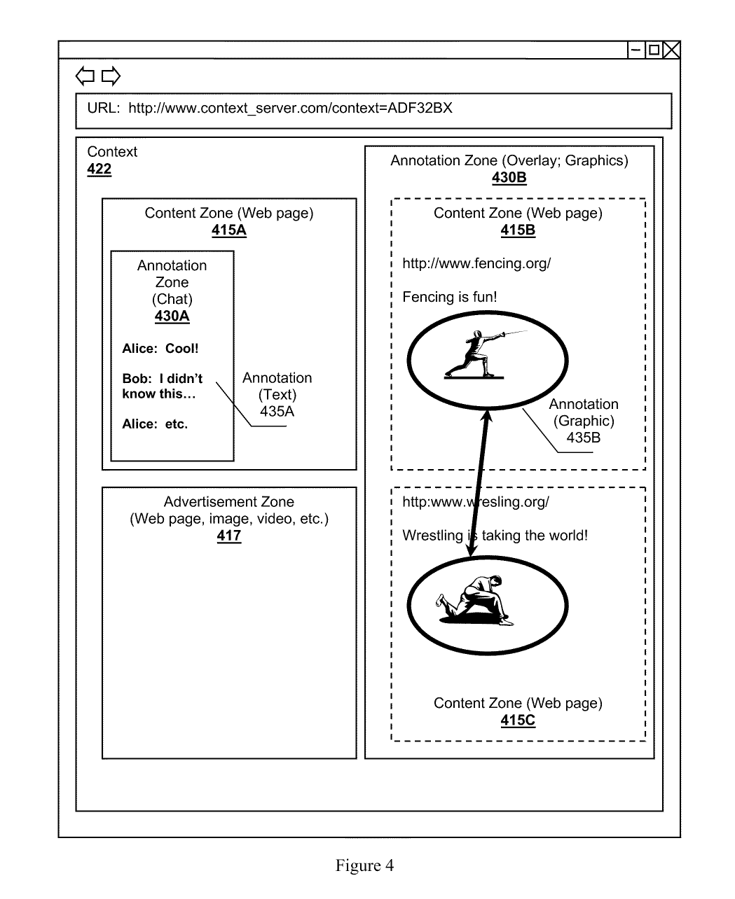

An especially preferred type of metadata includes annotations. In the example shown, a context composer can interact with annotation zone 230 to annotate their context creation. A context can be annotated with various forms of additional data to allow a context composer to further clarify how the various forms of content relate to each other. For example, a user could graphically circle portions of content in content zone 215A and draw an arrow to content in zone 215B (see FIG. 4 for more information). Annotations can take on different forms. Example annotations include audio annotations, graphic annotations, text annotations, real-time chat annotations, or other types of annotations. An astute reader will appreciate that real-time chat annotations imply that multiple individuals including the context recipient or the context composer can annotate a context as desired.

At least two points should be immediately appreciated by the reader. First, annotation zone 230 can represent an annotation interface through which the context composer can define zone 230 as desired. For example, composer can utilize zone 230 to set one or more parameters associated with zone 230 reflecting how users can interact with zone 230 to submit or otherwise manage annotations. Example annotation zone parameters can include zone type (e.g., an overlay, a text chat box, a rating scale, a media player, etc.), a position of one or more zones 230 based on relative or absolute locations with respect to a context or its content, a set of permission or access levels, a visibility, or other annotation zone properties. All annotation zone properties are contemplated.

The second point that should be appreciated is a context composer can use annotation zone 230 to submit annotations that are bound to the context, assuming a suitable set of annotations zones 230 have been properly established. Binding submitted annotations to a context can be achieved using many different suitable techniques.

In some embodiments, annotations can be bound to a context by linking one or more of annotation zones 230 to individual content zones 215 where the two zones are presented in proximity to each other.

In other more complex embodiments, annotations can be bound according to their position relative to the context as a whole, possibly through an overlay managed by an annotation manger on the context server. Each annotation within annotation zone 230 could be assigned a bounding box that can be graphically displayed according to an absolute position within the context. It is also contemplated that annotations can be placed in relative positions to each of content zones 215. It is yet further contemplated that annotations can maintain their relative placement to portions of content displayed within content zones 215. As content in one of zones 215 moves, the context server can update the annotation interface to adjust the annotations accordingly by repositioning the annotations within the annotation interface. The inventive subject matter is considered to comprise binding annotations to an arrangement of a context, to content zones, or to portions of content, and to comprise modifying a presentation of the context to include the annotations according to the bindings.

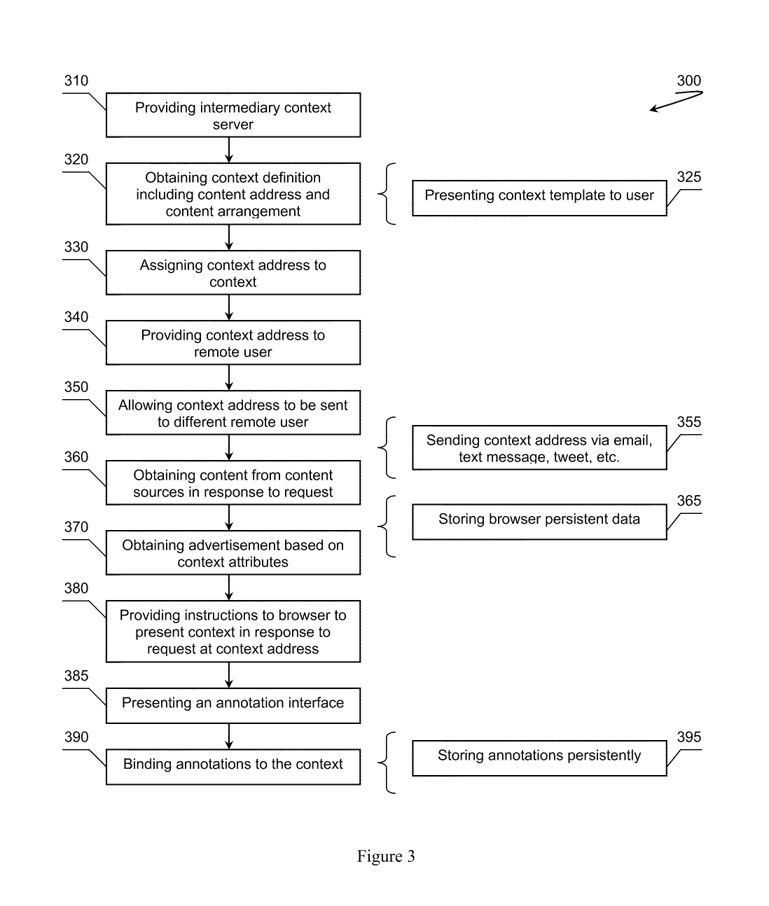

To provide additional clarity, FIG. 3 presents a possible method for aggregating on-line content via a proxy context server. In some embodiments, a proxy context server can be operated as a for-fee service to users, browsers, advertisers, or other entities that appreciate a context is a valuable commodity. An example system that can be used as part of the disclosed inventive subject matter includes those provided by Tarfoo™, Inc. The aggregated content can pass through the server and can be presented to a client device, preferably configured with browser functionality. In a preferred embodiment, client device presents the content according to the pre-defined context. Aggregated content can include web-based media (e.g., images, audio, applications, games, etc.) as well as locally hosted application data (e.g., documents, spreadsheets, presentations, annotations, etc.).

An initial step 310 can include providing an intermediary context proxy server. The content proxy server is preferably configured to obtain content from one or more remote, independent content sources, possibly web servers on the Internet. One should appreciate that the step of providing a server can be considered simply making a server available over a network, or installing suitable software on a server. In some embodiments, the proxy context server can be integrated with or within other types of Internet based services including social networking sites, possibly as a web service or other form of consumable web accessible API.

A user can define a context via a context interface preferably provided by a for-fee proxy aggregated browser service hosted on one or more servers. The user defines the context by selecting content, possibly via a web-link, and arranging the content as desired. The context can be considered a “view” of how the content should be rendered. The for-fee service can generate revenue through subscribers that pay for the ability to define contexts, fees for disabling advertisers, or payments from advertisers to place advertisements within contexts based on context attributes. For examples, advertisers could bid via an auction to gain the right to place advertisements based on context attributes including arrangements, metadata, identified theme, annotations, or other context attributes.

Step 320 is considered to include obtaining a context definition that defines a context in terms of one or more context attributes. Preferably the context definition includes content attributes that comprises at least content network addresses where content can be obtained over the network, and an arrangement of the content within the context. As discussed previously, a context composer or a context manager can bind additional attributes to a context as desired. Step 325 can further include the option of presenting a user a context template, possibly an a priori defined template, which the user can fill out to create a context or to annotate a context.

As discussed previously, a user can input one or more context attributes to define a context. Context attributes can include URLs, ratings, metadata, locations, time stamps, annotations, or other characteristics.

With respect to a context's arrangement, an arrangement of the content can include more content zones placed around a display of the browsing device. In some embodiments, the content zones can be rendered as a 2D representation or a 3D representation. In some embodiments, the content zones are presented as frames, or quadrants. It is also contemplated that the arrangement of content can include temporal aspects where a specified content is rendered for a period of time in a content zone then replaced by a different content. Preferably a context includes at least two or more content zones. It is thought that 2, 4, or 6 content zones would fit most uses. However, larger numbers of content zones are also contemplated (e.g., greater than 10, 20, 50 or even over 100 zones). One should note that content zones do not necessarily have to be visible, but could lack a visual representation. For example, a content zone could also include one or more audio channels, or even one or more data sockets used to accept application data.

Once a user is satisfied with a defined context, a web-link or other form of context network address can be associated with the context, where the link (e.g., IP address, URL, URI, web services API, etc.) references the proxy browsing service and identifies the context. For example, if the proxy context server is located at www.tarfoo.com, then a context might have a context address similar to www.tarfoo.com/context=<GUID> where GUID represents a unique identifier that points to the context.

Therefore, method 300 can comprise step 330, which includes assigning the defined context a context network address. The context network address preferably represents a single network location through which a browser can obtain access to the context, assuming proper authentication or authorization. Preferably the address reflects the address of the context server. The context network address can also include other information as desired to facilitate operation of the overall system. Additional information could include authorization codes, keys, advertising identifiers, permission levels, or other encoded data that can be used to aid in providing access to the context.

At step 340, once the context has an assigned network address, or other context identifier, the address can be provided to a user through various communication channels as desired. In some embodiments, a context manager generates the context network address and provides the context network address to the context composer. For example, upon submission of the context, the context manager can cause the context interface to present a URL to the composer by which others can access the context.

Step 350 further contemplates allowing the context address to be sent to other remote users, assuming proper authentication or authorization. Typically, it is expected that the context composer would provide the context network addresses to one or more desired recipients, possibly via email. The context manager “allows” the composer to send a context in the sense that no restrictions are placed on forwarding the context network address to one or more recipients. It is also expected that the context server can be configured to send the context network address. Step 355 suggests that a context network address can be sent through various communication channels including email, instant messaging, text message, twitter, social networking blog posts, or other channels. Upon reception of the context network address, the recipient can simply click on the address to launch a browser, which in turn obtains the context and renders the context image.

In some embodiments, at step 360 a context server can obtain content in response to receiving a context request from the recipient. The server can consult a context database to look up a context based on a context identifier associated with the context network address at which the context request was made. The server can obtain the context's defining attributes (e.g., arrangement data, metadata, content addresses, annotations, advertising information, etc.) from the context database in preparation for constructing the context on the recipient's browser. Furthermore, the server can determine the arrangement of the context by analyzing the context attributes including the geometry or format of the context arrangement. The step of obtaining the context could be performed before the context request arrives. Such an approach can be achieved through caching the content. In other embodiments the content is only obtained after a request for the context is received at the context network address (e.g., URL). One possible reason for waiting to obtain the content is to address temporal issues associated with the obtained content to ensure the content is the most up to date version. For example, a blog might have newer content that should be displayed over older content. In yet other embodiments where content is cached locally or remotely, the context could be constructed to represent a snap shot in time. One should appreciate that a context could also represent changes in a single set of content where each content zone provides a snap shot of the content at different times.

Step 365 further indicates a context server can store persistent data required to support proxy browsing on behalf of one or more recipients. For example, browser-based persistent data can be stored on a recipient by recipient basis. Example persistent data can include a browser history, cookies, authorization or authentication data, or other data. Storing persistent data provides for returning to a context at a later time, especially where persistent data is useful, possibly to support filing out forms, storing preferences to a remote site, remember purchasing information, or other purposes.

In some embodiments, the system can be configured to hide browsing history or cookies for security purposes. In other embodiments, the system can be configured to retain browsing history or cookies, where the retained information can be made available from the client browsing device or from the context server.

It is also contemplated advertisement data can be inserted into the context at step 370 by obtaining advertisements based on the context attributes, including annotations. One should note that the context can be treated as a whole as opposed to individual contents. Therefore interesting information can be derived from the context as an object distinct from the content. Examples can include automatically identifying a unifying theme of the contest derived from the content, deriving a relative importance of each piece of content based on position, or other information. For example, if all the content in a context is related to weddings, the server could determine through correlating keywords with concepts that the context pertains to marriage. The server can then provide advertisements for marriage related goods or services.

The inventive subject matter is considered to include identification of advertisements that relate to a context based on the context's defining attributes. As mentioned briefly above, advertisements can be matched to a context based on the context's annotations, arrangement, theme, or other defining characteristics.

Advertising content can be integrated into a context based on the aggregation of content, the arrangement of the content in the context, or even based on how the context is shared. In some embodiments, advertising content can be integrated into the context based on the type of content data; video conferencing data, social networking data, news data, gaming data, or other types of data. In a preferred embodiment, an intermediary service hosted on one or more servers can track the number of impressions an advertisement has made based on the number of views of a context, the number of times a context has been shared, or other context attributes.

Step 380 includes providing instructions to a browser that requested the context. The instructions can include browser related codes or instructions possibly based on HTML, scripts, programmatic code, or other computer related control data. The server can automatically generate such instructions in real-time, the server could simply present the content within predefined template pages as desired, or the server can present the context using any other suitable known technique.

Step 385 can further enhance method 300 by presenting an annotation interface to the context recipient; preferably presenting the interface proximal to the context. Preferred annotation interfaces are configured to allow the context recipient, or other user observing a context, to submit annotations to the intermediary context server. In more complex embodiments, the annotation interface can also provide one or more annotation management functions to the recipient that allow the recipient to modify annotations or their arrangement within a context. The annotation interface can be presented as a context overlay, possibly visible or non-visible to one or more recipients, which can support submission of graphic annotations. Other types of annotation interfaces can include chat boxes, rating scales, graphic or drawing zones, or other types of annotation interface zones. One should also appreciate that the annotation interface can comprise more than one annotation zone. There could more, less, or an equal number of annotations zones relative to the number of content zones within the context.

Step 390 can include binding annotations relative to the arrangement of the context. Binding can include binding annotation zones relative to the arrangement of the context according to absolute positions or relative positions. Furthermore, binding annotations can occur relative to the context zones, portions of the context, relative to other annotation zones, or according to other desired annotation arrangements.

One should note, presenting an annotation interface is also considered to include modifying a presentation of the context to include annotations according to the bindings established in step 390. For example, when a context composer is annotating their context, the context server can update a preview of the context to include the annotations. In addition, when a recipient is viewing a context, the recipient along with other recipients can provide real-time annotations. An annotation manager within the context server can update each recipient's annotation interface in real-time to reflect annotations entered. Such an approach provides for sharing or otherwise collaborating among multiple recipients while viewing a shared context.

Step 395 further contemplates that annotations can be stored persistently, preferably bound to the context for which the annotations were made. Storing persistently is considered to include storing changes made to the context so other can observer a temporal flow of an over arching theme. Such an approach is considered highly advantageous especially in view of a dynamic context where content can change with time.

FIG. 4 presents an example of a context 422 presented to a context recipient where context 422 includes multiple exemplary annotation interfaces represented by annotation zones 430A and 430B, collectively referred to as annotation interface 430. The context recipient has received a single URL to which the recipient directs his preferred browser. The URL represents a context network address located on an intermediary context server configured to be responsive to the context request. In response to receiving the context request the context server uses a context identifier in the context network address to determine what content should be obtained from remote sources and what arrangement is required. The server instructs the recipient's browser to construct the context according the context's defined arrangement for the content. In the example shown, context 422 comprises four main content zones 415A, 415B, 415C, and advertisement zone 417. Note content zones 415B and 415C are shown with dashed lines to indicate they are beneath annotation zone 430B. The server, by proxy, obtains necessary content or advertisements for display in context 422. In addition, the server also presents annotation interface 430 along with annotations 435A and 435B according to their bindings to context 422.

The example illustrates two of the many possible types of annotation interface 430. Annotation zone 430A represents a real-time chat box super imposed over content zone 415A. Recipients Alice and Bob have a real-time instant messaging session associated with context 422 where annotation 435A represents text-based annotations. It should be appreciated that one or more of annotation zone 430A could be bound to each content zone, to context 422 as a whole, or according to any other desired arrangement.

In some embodiments, annotations interface 430 can be constructed as an additional content zone where annotations are integrated into the overall context. Such an approach is considered advantageous for annotations that would likely be considered static. Additionally, treating annotation interface 430 as a content zone reduces processing requirements for a context server by reducing effort required to maintain different type of display objects or document containers.

Annotation zone 430B represents an overlay that is transparent, or at least semi-transparent, allowing recipients to view content zones 415B and 415C (represented with dashed lines to indicate they are beneath zone 430B) as they annotate content zones 415B and 415C together. In this example, annotations 435B take the form of graphic-base annotations. A recipient has graphically circled portions of content in each context zone and linked them together. In some embodiments, the annotations retain their relative positions to the portions of the content. Should content of content zone 415B scroll, the circle of the image can also move relative to the portion. One should also note that graphic links between two or more annotations could also “stretch” in response to movement of each annotation to retain the linkage among annotation objects. Such a feature can be achieved by binding annotations relative the portions of the content presented in each of the content zones.

FIG. 4 presents only a few types of annotation zones within an annotation interface 430. Other types of annotation zones can include rating scales, metadata tagging interfaces, audio tagging interfaces, permission controls interfaces, or other types of annotation zones. It is also contemplated that a viewer could adjust an annotation zone in real-time possibly to stretch its boundaries (e.g., adjust zone 430B to cover zone 215A and zone 217), change permissions, or otherwise manage annotation interface 430.

The rendering of the content, including annotations, can be prioritized based on user criteria, or other criteria. For example, the size or dimension of the various zones can be adjusted based on detected display device attributes, resources used, or other attributes. The content can be prioritized for rendering based on a user's preferences, on ratings of the content, on the number of views of the content, frequency of access, or yet other attributes. The context can be provided to a local browsing display (e.g., cell phone, computer, TV, etc.), where the context provides instructions to divide the display into content zones. The content zones could be frames, windows, quadrants, bitmaps mapped to rendered 3D surface, or other display objects. The content of the context can then be displayed in the various zones according to the context.

A context can also be presented to a user in a manner where the user can interact with the context as a whole as opposed to merely interacting with individual content. For example, a user could rate the context as a whole, or rank each of content elements relative to another element, possibly through an annotation interface as discussed above. Another example includes sharing a context with other users, possibly in a chatting environment, in a social networking environment, in a gaming environment, in an advertising environment, or in other environments. All manner of interacting with a context as whole is contemplated including through annotation interfaces.

In some embodiments, content within a context could conflict with other content or annotations. For example, if a context's content includes multiple audio data streams, it is preferred that only one of the audio data streams should be played at a given time. Conflicts can be resoled by based on one or more context attributes possibly including a proximity of a user's cursor in the context, frequency of access to the content, a rating of the content, zone location, annotations, user set priorities, or other attributes. It is also contemplated that an annotation interface can provide for controlling exclusivity of presenting annotations according to different modality. For example, one individual can have exclusive control over presenting audio annotations while another individual could have exclusive control over presenting graphic annotations.

In some embodiments, a context can be configured to present content in a manner other than what was originally intended. The content can be transformed from one modality to another before being presented to a context recipient. For example, rather than sending content as text data (e.g., HTML, etc.), the content can be pre-rendered as an image file where the image file is sent to the content recipient's display device. The image file could simply be a graphic image of what web page would ordinarily look like when properly rendered. The image would lack any of the original text data. Such an approach is thought to reduce the risk of an un-authorized third party eavesdropping on a browser session. Preferably, the rendered image file retains functionality of the original content, preferably through interaction with an intermediary proxy browser server.

Yet still another embodiment includes a distributed computing system where contexts can be used as an interface to a distributed computing infrastructure. A context server can aggregate application data from a plurality of independent application servers, possibly available over the Internet, where the application data represents content for a context. Preferably, an application context can be presented within a browser so that a user can access their computing environment from any browser enabled computer located anywhere there is network connectivity. The context could be considered a state of an application running within a cloud computing infrastructure where the state can be stored and restored from one computing session to another. It is specifically contemplated that a context could be presented as a web page within browser. It is also contemplated that a context could represent a web service that aggregates multiple web services. For example, multiple web service APIs can be aggregated and presented as a single API, or a transformed into a single, simplified web services API. In a preferred embodiment, an application context is managed by an intermediary data aggregation service operating between a client and the remote web-based computing infrastructure. In such embodiments, an annotation interface can represent a debugging interface for the distributed application.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A context server capable of supporting annotation of a context, the server comprising:
an intermediary context server communicatively coupled between a context recipient and a plurality of remote independent content sources over a network, the context server configured to:
configured a present a context comprising a context identifier and an arrangement of content obtained from the content sources in response to a context request including the context identifier from the context recipient;
configured to present to the context recipient an annotation interface proximal to the context, the annotation interface allowing the context recipient to submit annotations to the intermediary context server;
configured to bind the annotations relative to the arrangement of context; and
configured to modify a presentation of the context to include the annotations according to the binding.

2. The server of claim 1, wherein the annotation interface comprises an annotation overlay of the context.

3. The server of claim 2, wherein the annotation overlay is visible to a user.

4. The server of claim 2, wherein the annotation overlay provides for graphic annotations.

5. The server of claim 1, wherein the context is shared among multiple remote context recipients.

6. The server of claim 5, wherein the presentation of the context including the annotations is updated in real-time on annotation interfaces of the remote context recipients.

7. The server of claim 1, the server further configured to store the annotations persistently.

8. The server of claim 7, wherein the annotations are integrated into the context within a content zone of the context.

9. The server of claim 1, wherein the annotation interface comprises a plurality of annotation zones.

10. The server of claim 9, wherein the annotation interface comprises at least one annotation zone for each content zone of the context.

11. The server of claim 1, wherein the annotation interface provides for capturing one of the following types of annotations: a text input, an audio input, and an image input.
